(19) United States
(12) Patent Application Publication
(10) Pub. No.: US 2007/0070113 A1
(43) Pub. Date: Mar. 29, 2007

(54) RECORDING APPARATUS AND LIQUID EJECTING APPARATUS

(75) Inventors: Seiji Kawabata, Suwa-shi, Nagano-ken (JP); Hiroshi Hamakawa, Suwa-shi, Nagano-ken (JP); Nobuyuki Nishi, Suwa-shi, Nagano-ken (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/533,298

(22) Filed: Sep. 19, 2006

(30) Foreign Application Priority Data
Sep. 20, 2005 (JP) 2005-272586

(51) Int. Cl. B41J 2/015

(52) U.S. Cl. 347/20

(57) ABSTRACT

A recording apparatus includes a recording head that performs recording on a recording medium and a recording medium transporting unit that is disposed on the upstream side of the recording head and transports the recording medium toward the recording head. The recording apparatus also includes a recording medium discharging unit disposed on the downstream side of the recording head and discharges the recording medium on which recording has been performed. A platen faces the recording head, and defines a gap between the recording medium and the recording head by supporting the recording medium. The recording medium transporting unit includes a transport driving roller that rotates, and a plurality of transport driven rollers that are spaced apart from one another in a main-scanning direction by a suitable distance and come in pressure contact with the transport driving roller to be driven to rotate.

### BACKGROUND

1. Technical Field

The present invention relates to a recording apparatus performing recording on a recording medium, and a liquid eject apparatus.

Here, the liquid ejecting apparatus is not limited to a kind of recording apparatus such as a printer, a copy machine, or a fax machine in which an ink jet type recording head is used so that ink is ejected from the recording head and thereby recording is performed on a recording medium. The liquid ejecting apparatus also includes a kind of apparatus in which liquid utilized in place of ink for its equivalent usage is injected onto an target medium corresponding to the recording medium from a liquid ejecting head corresponding to the ink jet type recording head, and the liquid is attached onto the target medium.

In addition to the recording head, examples of the liquid eject head include a color material ejecting head that is used when manufacturing a color filter such as a liquid crystal display, an electrode material (a conductive paste) ejecting head that is used to form an electrode such as an organic EL display or a field emission display (FED), a bio-organic matter ejecting head that is used in bio-chip manufacturing, and a sample ejecting head that is used as a precision pipette.

2. Related Art

An ink jet printer is an example of a recording apparatus or a liquid ejecting apparatus. The ink jet printer includes a platen which defines a gap (a paper gap: hereinafter referred to as PG) between an ink jet recording head and a sheet of printing paper by supporting the sheet of printing paper from the bottom side at a position facing the ink jet recording head that ejects ink (liquid) onto the sheet of printing medium serving as a recording medium (an injected medium).

In such a configuration, as disclosed in JP-A-2003-291430 and JP-A-2004-322632, a plurality of ribs that extend in a sub-scanning direction are disposed, being spaced from one another in a main-scanning direction, on a surface where the platen faces the ink jet recording head. This is done to form a waveform state (so-called cockling state) having a specific amplitude on the sheet of printing paper that expands when absorbing ink, so that an elongated portion due to expansion of the printing medium is absorbed between the ribs, thereby allowing the distance between the printing surface and the ink jet recording head to be constant as much as possible.

JP-A-2003-291430 discloses an aspect in which the cockling is produced by co-operating a rib and a discharging roller. However, since cockling is not produced in paper until the leading edge of the paper reaches the discharging roller, the PG is likely to be uneven when the leading edge of the paper is printed. Therefore, in JP-A--2003-291430, a rib having a low height is used to allow the leading edge of the paper to be easily fed between a rib and another rib. Occasionally, however, cockling is not formed in a sufficient manner according to a paper type.

JP-A--2004-322632 discloses an aspect in which a pressing unit is disposed between two ribs so as to press the paper toward a platen. In this manner, it can be said that cockling is produced by co-operating the pressing unit and the ribs at least until the leading edge of the paper reaches the discharging roller. However, installation of the pressing unit causes a complex structure and an increase in cost.

### SUMMARY

An advantage of some aspects of the invention is to provide a recording apparatus in which cockling is not formed in a leading edge of paper without causing a complex structure and a cost increase.

According to a first aspect of the invention, there is provided a recording apparatus comprising: a recording head that performs recording on a recording medium; a recording medium transporting unit that is disposed on the upstream side of the recording head, and transports the recording medium toward the recording head; a recording medium discharging unit that is disposed on the downstream side of the recording head, and discharges the recording medium on which recording has been performed; and a platen that is disposed so as to face the recording head, and defines a gap between the recording medium and the recording head by supporting the recording medium. The recording medium transporting unit includes a transport driving roller that rotates, And a plurality of transport driven rollers that are spaced apart from one another in a main-scanning direction by a suitable distance and come in pressure contact with the transport driving roller to be driven to rotate. The recording medium discharging unit includes a plurality of discharge driving rollers that are spaced apart from one another in the main-scanning direction by a suitable distance, and a plurality of discharge driven rollers that are driven to rotate while being in contact with the discharge driving rollers. In the platen, a plurality of ribs that extend in a sub-scanning direction are disposed in a portion facing the recording head in the main-scanning direction while being spaced apart from one another by a suitable distance. Locations of the ribs in the main-scanning direction coincide with the positions of the discharge driving roller and the discharge driven roller, and a load is concentrated at a position between each adjacent pair of ribs when the recording medium is pressed in a pinch manner by the transport driving roller and the transport driven roller.

The a position, at which the load is concentrated when the recording medium is pressed in a pinch manner by the transport driving roller and the, transport driven roller, is likely to be a valley portion when cockling is formed in the recording medium. Therefore, by using this property, when the position where the load is concentrated is interposed between two ribs, the cockling can be formed such that, in the recording medium, a position of a rib forms a ridge portion, and the position where the load is concentrated forms a valley portion. Accordingly, it becomes possible to allow the cockling to be formed in the leading edge of the recording medium without causing a complex structure and a cost increase. Further, recording quality can be avoided against deterioration in the leading edge of the recording medium.

According to a second aspect of the invention, in the first aspect of the invention, the ribs and the positions at which the load is concentrated are alternated.

In this case, the ribs and the positions at which the load is concentrated are alternated, and thereby convex and concave portions of the cockling are alternately formed in a regular manner. Therefore, deterioration in printing quality can be further prevented with certainty.

According to a third aspect of the invention, in the first aspect of the invention, the ribs are arranged so as to support underneath both side edges of the recording medium in the main scanning direction, and the ribs supporting both side edges of the recoded medium are formed such that protrusion heights thereof toward the recording head are lower than those of other ribs having the same protrusion height and supporting underneath the recording medium.

In this case, since the ribs supporting the both edge portions of the recording medium are formed such that the protrusion heights thereof toward the recording head are lower than those of other ribs having the same protrusion height and supporting underneath the recording medium between the both edge portions, even when the recording medium is deformed such that the center portion is convexly curved toward the recording head (for example, similar to the case of paper in which its coating layer absorbs moisture and thus expands and of which the recording surface is formed with the coating layer), the distance between the recording surface and the recording head can be secured, thereby preventing a head friction or the like.

According to a fourth aspect of the invention, in the first aspect of the invention, the recording apparatus comprises an auxiliary roller that is located between the recording head and the recording medium discharge unit, and is driven to rotate while being in contact with the recording surface of the recoded medium, wherein two auxiliary rollers ate disposed between the ribs.

In this case, since the recording apparatus comprises an auxiliary roller that is located between the recording head and the recording medium discharge unit, and is driven to rotate while being in contact with the recording surface of the recoded medium, and two auxiliary rollers are disposed between the ribs, the valley portion of the cockling can be further surely formed between the two ribs.

According to a fifth aspect of the invention, there is provided a liquid ejecting apparatus comprising: a liquid ejecting head that injects liquid onto an injected medium; an target medium transporting unit that is disposed on the upstream side of the liquid ejecting head, and transports the target medium toward the liquid ejecting head; an target medium discharging unit that is disposed on the downstream side of the liquid ejecting head, and discharges the target medium on which liquid has been ejected; and a platen that is disposed so as to face the liquid ejecting head, and defines a gap between the injected medium and the liquid ejecting head by,supporting the injected medium. The target medium transporting unit includes a transport driving roller that rotates, and a plurality of transport driven rollers that are spaced apart from one another in the widthwise direction of the target medium by a suitable distance and come in pressure contact with the transport driving roller to be driven to rotate. The target medium discharging unit includes a plurality of discharge driving rollers that are spaced apart from one another in the widthwise direction of the target medium by a suitable distance, and a plurality of discharge driven rollers that are driven to rotate while being in contact with the discharge driving rollers. In the platen, a plurality of ribs that extend in a sub-scanning direction are disposed in a portion facing the liquid ejecting head in the main-scanning direction of the target medium while being spaced apart from one another by a suitable distance. Locations of the ribs in the widthwise direction of the target medium coincide with the positions of the discharge driving roller and the discharge driven roller, and a load is concentrated at a position between each adjacent pair of ribs when the target medium is pressed in a pinch manner by the transport driving roller and the transport driven roller.

### BRIEF DESCRIPTION OF THE DRAWINGS

The invention will be described with reference to the accompanying drawings, wherein like numbers reference like elements.

FIG. 1 is a perspective view showing an exterior of a main body of a printer according to an embodiment of the invention.

FIG. 2 is a side cross-sectional view of a printer according to an embodiment of the invention.

FIG. 3 is a perspective view showing a main part of a recording unit around a lower paper guide.

FIG. 4 is a side cross-sectional view of a recording unit around a lower paper guide.

FIG. 5 is a schematic view showing a positional relationship among a first rib, a second rib, and a third rib.

FIG. 6 is a plan view showing a positional relationship among a transport driven roller, each rib, and a discharge driving roller.

FIG. 7 is a plan view showing a positional relationship among a transport driven roller, each rib, and a discharge driving roller.

### DESCRIPTION OF EXEMPLARY EMBODIMENTS

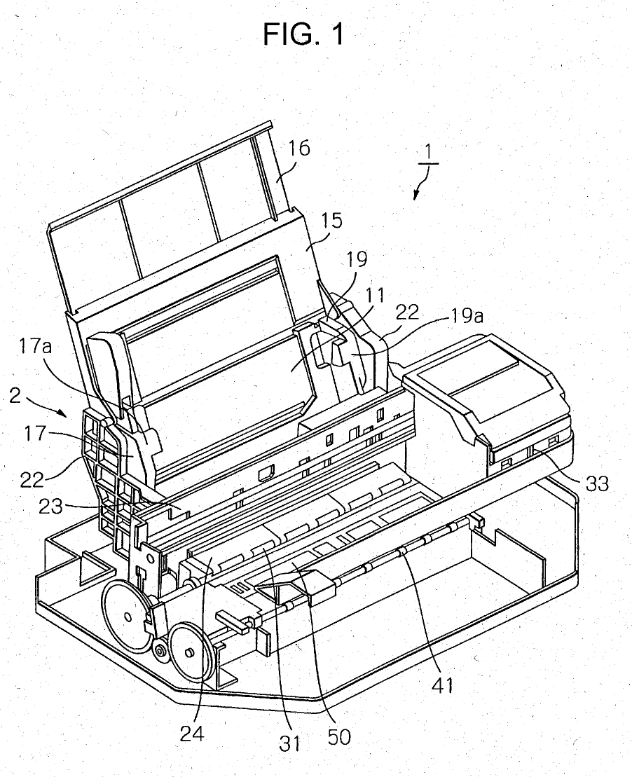

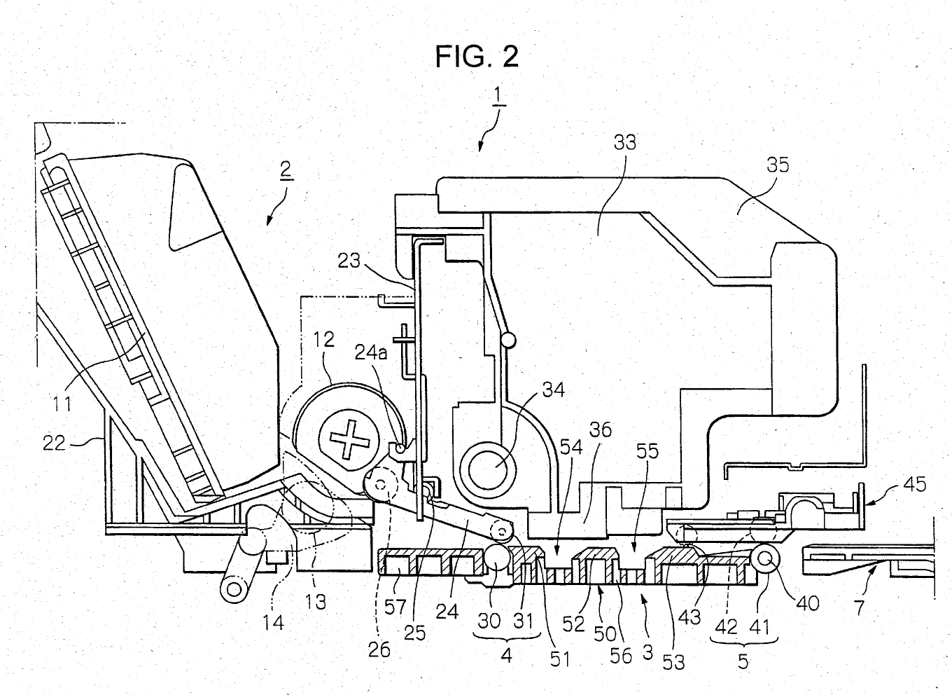

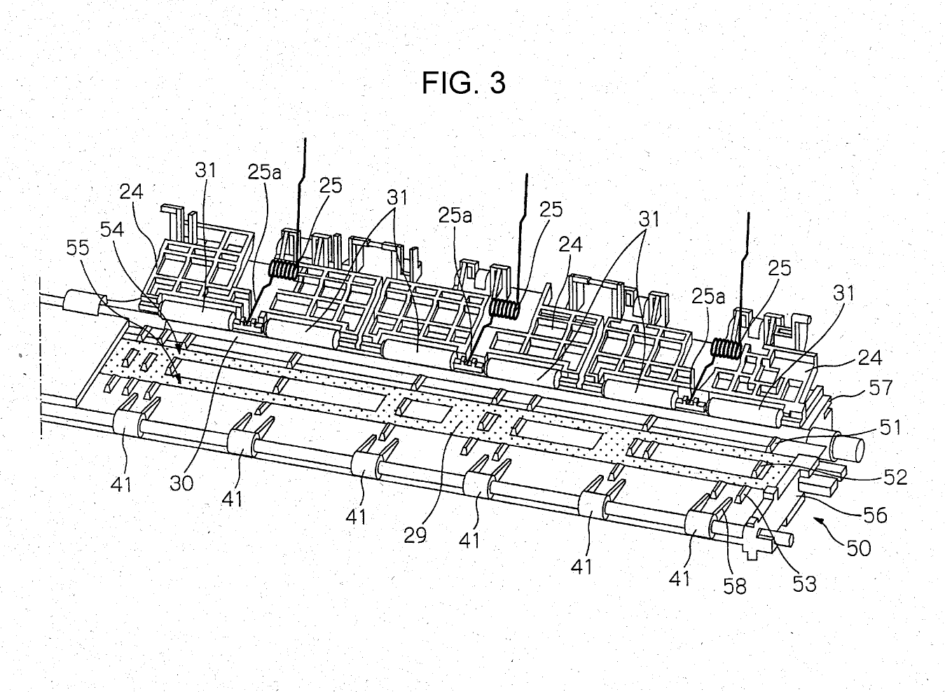

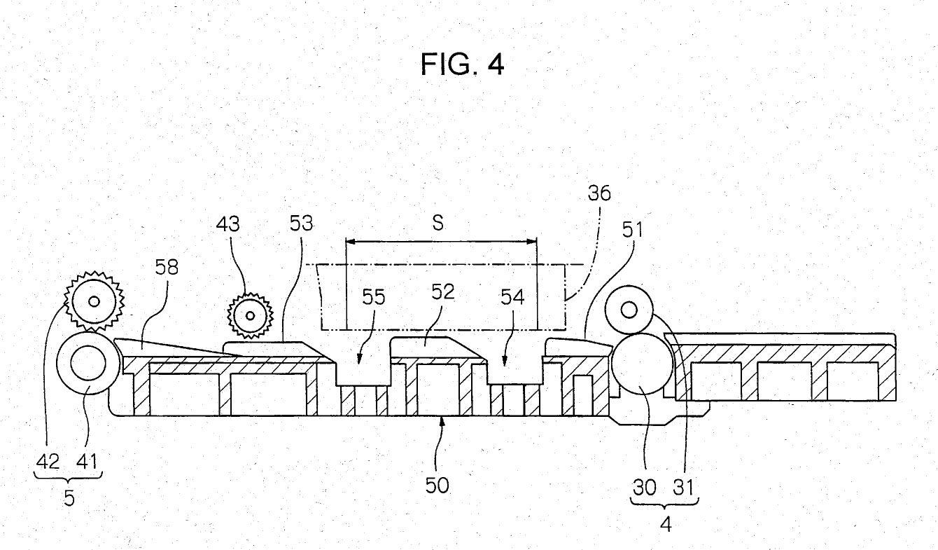

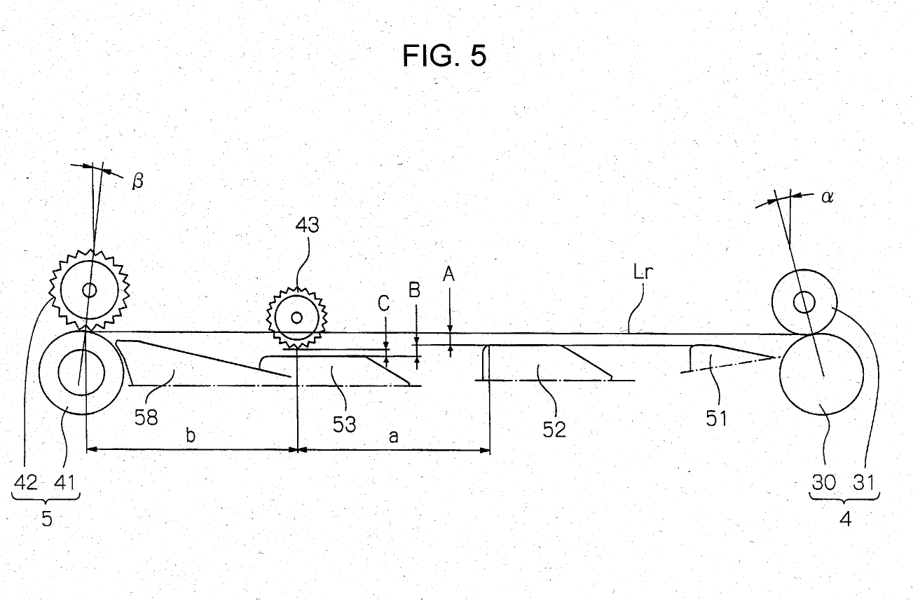

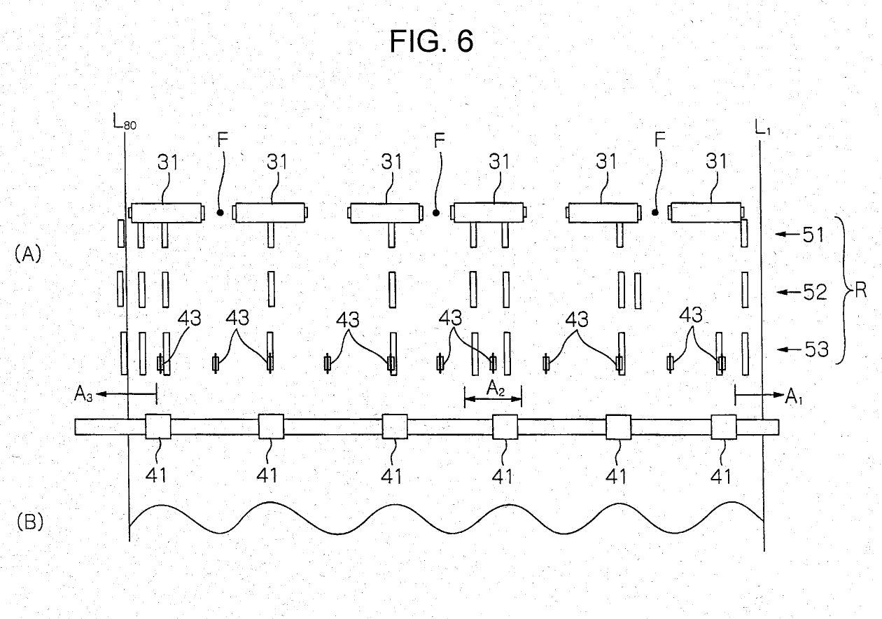

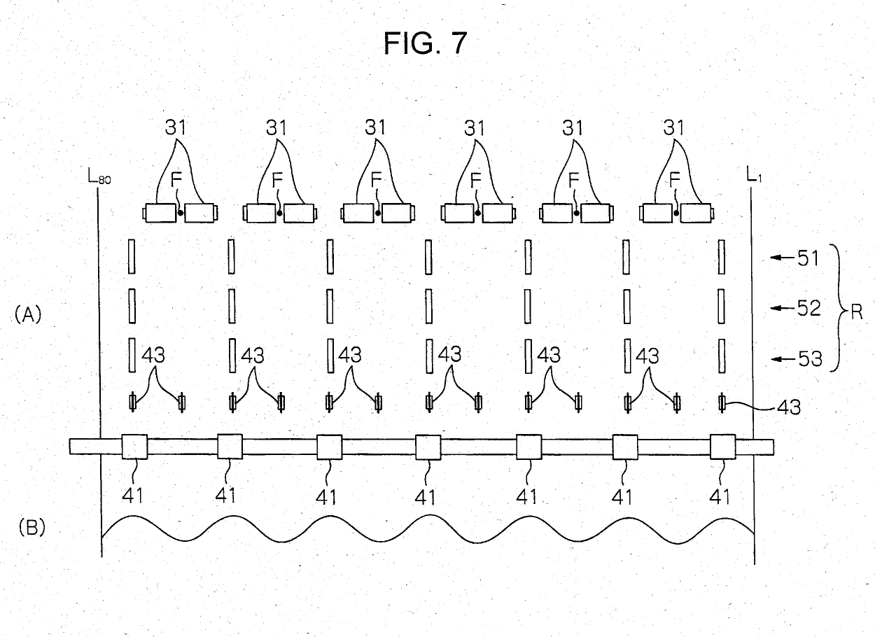

Hereinafter, exemplary embodiments of the invention will be described with reference to FIGS. 1 to 7. FIG. 1 is a perspective view showing an exterior (in a condition that its external casing is detached) of a main body of a printer 1. FIG. 2 is a side cross-sectional view of FIG. 1. FIG. 3 is a perspective view showing the main part of a recording unit 3 around a lower paper guide 50. FIG. 4 is a side cross-sectional view of FIG. 3. FIG. 5 is a schematic view showing a positional relationship among a first rib 51, a second rib 52, and a third rib 53. FIGS. 6 and 7 are plan views showing a positional relationship among a transport driven roller 31, a first rib 51, a second rib 52, a third rib 53, and a discharge driving roller 41.

First, an ink jet printer (hereinafter referred to as a printer) as an example of a recording apparatus or a liquid ejecting apparatus related to the invention will be described in brief with reference to FIGS. 1 and 2. Hereinafter, the right direction in FIG. 2 and the left direction (the front side of the printer 1) in FIGS. 4 and 5 are defined as the downstream side, and the left direction in FIG. 2 and the right direction (the rear side of the printer 1) in FIGS. 4 and 5 are defined as the upstream side.

The rear side of the printer 1 is provided with a feeding unit 2 that can set recording paper (mainly a sheet of paper: hereinafter referred to as paper P) thereon in a tilted manner as an example of a recording medium or an target medium. The paper P is fed toward a recording medium transporting unit 4 located on the downstream side of the feeding unit 2. The fed paper P is transported (transferred in the sub-scanning direction) to the recording unit 3 located on the downstream side by means of a recording medium transporting unit 4, and then recording begins. Further, the paper P, on which recording has been performed by the recording unit 3, is discharged to the front side of the apparatus by a recording medium discharging unit 5.

Now, elements disposed along the paper transporting path of the printer 1 will be described in detail. The feeding unit 2 includes a hopper 11, a feeding roller 12, a retard roller 13, a return lever 14, a paper support 15, an auxiliary support 16, a movable edge guide 17, and a fixed edge guide 19.

The hopper 11 formed from a plate shape element, and constructed to be able to pivot about a pivot center (not shown) provided in an upper part of hopper 11. While pivoting, the hopper 11 switches between a pressure contact position, at which the paper P supported on the hopper 11 in a tilted manner comes in pressure contact with the feeding roller 12, and a separation position at which the paper P is separated from the feeding roller 12. The feeding roller 12 has a substantial D shape when viewed laterally. The paper P, which is fed from the top while being in pressure contact with the circular arc portion of the feeding roller 12, is fed toward the downstream side. After the paper P is fed, the flat portion of the feeding roller 12 is regulated to face the paper P as shown in the drawing in order to avoid a transporting load while the paper P is transported by the recording medium transporting unit 4.

The outer circumferential surface of the retard roller 13 is formed of an elastic material, and is disposed to be able to come in pressure contact with the circular arc portion of the feeding roller 12, while a specific rotation resistance (torque) is imposed thereon. When only one sheet of the paper P is transferred without occurrence of double feeding, the torque imposed on the retard roller 13 is equal to or greater than the rotation resistance. Thus, the retard roller 13 rotates (clockwise rotation of FIG. 2), driven by the feeding roller 12. On the other hand, when a plurality of sheets of the paper P are present between the feeding roller 12 and the retard roller 13, the friction coefficient between the sheets of the paper P is lower than the friction coefficient between the paper P and the retard roller 13. As a result, since the torque imposed on the retard roller 13 is less than the rotation resistance, the retard roller 13 does not rotate and is in a stationary state. Accordingly, the paper P placed below the second uppermost paper P, which is about to be double-transferred in conjunction with the uppermost paper P to be fed, is not transferred toward the downstream side of the retard roller 13, thereby preventing the paper P from double transferring.

The return lever 14 is disposed to be pivoted along the feeding path of the paper P, when viewed laterally. While pivoting, the paper P placed below the second uppermost paper P that is about to be double-transferred is returned to the hopper 11.

The paper support 15 and the auxiliary support 16 (FIG. 1) extend the paper supporting surface of the hopper 11 in the trailing edge direction of the paper P, so as to support the trailing edge of the paper P.

The movable edge guide 17 and the fixed edge guide 19 are disposed in the hopper 11 so as to face each other, and are in contact with the edges of the paper P to regulate edge positions. The movable edge guide 17 is disposed such that it can change its position (slide) in the widthwise direction of the paper P with respect to the hopper 11. Accordingly, the movable edge guide 17 can change its position to a desired position suitable for the width of the paper P.

Reference numbers 17a and 19a respectively denote regulating units of the movable edge guide 17 and the fixed edge guide 19. The regulating units 17a and 19a guide the paper P when the paper P is set. Further, the regulating units 17a and 19a regulate the maximum number (the maximum permissible number) of sheets of the paper P supported by the hopper 11 (set on the feeding unit 2)

A detecting unit (not shown) that-detects passing of the paper P, and a guide roller 26 that forms the feeding path of the paper P and reduces the transporting load by preventing the paper P from being in contact with the feeding roller 12 are disposed between the feeding unit 2 and the recording medium transporting unit 4.

The recording medium transporting unit 4 disposed on the downstream side of the feeding unit 2 includes a transport driving roller 30 that is rotated by a motor and the transport driven roller 31 that comes in pressure contact with the transport driving roller 30 and is driven by the transport driving roller 30. The transport driving roller 30 has an attaching layer which is formed by almost uniformly dispersing anti-abrasion particles onto the outer circumferential surface of a metal shaft that extends in the widthwise direction of the paper P. A plurality of transport driven rollers 31 have outer circumferential surfaces formed of a low friction material such as an elastomer, and are arranged in the axis line direction of the transport driving roller 30.

In the present embodiment, the shafts of two transport driven rollers 31 are held at one end portion of the downstream side of an upper paper guide 24. Three upper paper guides 24 are juxtaposed in the widthwise direction of the paper P as shown in FIG. 1. A shaft 24a is held at a main frame 23. Therefore, the upper paper guide 24 is disposed so as to pivot about the shaft 24a, when viewed from the paper transporting path, and is biased in a direction where the transport driven roller 31 comes in pressure contact with the transport driving roller 30 by means of a coil spring 25.

After the paper P reaches the recording medium transporting unit 4, the transport driving roller 30 rotates while being nipped between the transport driving roller 30 and the transport driven roller 31. Thus, the paper P is transferred to the recording unit 3 in the sub-scanning direction.

The recording unit 3 includes an ink jet recording head (hereinafter referred to as a recording head) 36 and a lower paper guide 50 (a platen 56) that is disposed so as to face the recording head 36. The recording head 36 is disposed under a base portion of a carriage 33. The carriage 33 is guided by a carriage guide shaft 34 that extends in the main-scanning direction (the widthwise direction of the paper P: a direction perpendicular to the plane of FIG. 2), and is driven to reciprocally move in the sub-scanning direction by means of a driving motor (not shown). Further, the carriage 33 includes a plurality of separate color ink cartridges 35, and supplies ink to the recording head 36.

The lower paper guide 50 (the platen 56) that regulates the distance between the paper P and the recording head 36 is provided with not only the first rib 51, the second rib 52, and the third rib 53 formed on a surface facing the recording head 36, but also grooves 54 and 55 for dumping ink. The ink ejected onto an area outside the edges of the paper P is dumped into the grooves 54 and 55, and thus so-called borderless printing is carried out in which the printed paper P has no black space around its edges. Further, the grooves 54 and 55 are disposed with an ink absorbing material 29 (see FIG. 3). A configuration of the lower paper guide 50 will be described below in detail.

The downstream side of the recording head 36 is disposed with an auxiliary roller 43 and the recording medium discharging unit 5. The auxiliary roller 43 is disposed such that it comes in contact with the recording surface of the paper P and rotates in a driven manner along the paper transporting path, which ranges from an area where the recording head 36 and the platen 56 face to the recording medium discharging unit 5. Therefore, the paper P can be prevented from lifting from the platen 56. Further, the auxiliary roller 43 uniformly maintains the distance between the paper P and the recording head 36 (details thereof will be described below). The recording medium discharging unit 5 includes the discharge driving roller 41 that is rotated by a motor (not shown) and the discharge driven roller 42 that is driven by the discharge driving roller 41 while being in contact with the discharge driving roller 41.

In the present embodiment, the discharge driving roller 41 is composed of a rubber roller. In addition, a plurality of discharge driven rollers 42 are disposed in the axis direction of a rotation axis 40 that rotates in conjunction therewith. In addition, the auxiliary roller 43 is disposed between the discharge driving roller 41 and two ribs in the main-scanning direction (details thereof will be described below).

A teeth-attached roller having a plurality of teeth on the outer circumferential surface thereof is used as the discharge driven roller 42 (the same applies to the auxiliary roller 43). A plurality of discharge driven rollers 42 are disposed in a discharging frame Assy45 being long in the main-scanning direction so as to correspond to the discharge driving rollers 41. The paper P on which recording has been performed by the recording unit 3 is discharged toward the front side (a not-shown stacker) of the apparatus when the discharge driving roller 41 rotates while being nipped by the discharge driving roller 41 and the discharge driven roller 42.

The structure of the printer 1 has been described above in brief. Moreover, the printer 1 is constructed such that ink jet recording can be directly performed on an optical disk (a thin film formed member) such as a CD-R, or an extremely rigid medium such as paperboard, in addition to a sheet of paper serving as the recording medium or the target medium. A tray guide 7 of FIG. 1 supports an extremely rigid medium such as a tray (not shown) in which the optical disk is set, or the paperboard. The extremely rigid medium is directed toward a rear side (the upstream side) of the printer 1 while being supported by the tray guide 7 disposed at the front side of the apparatus. Then, the extremely rigid medium is manually inserted into the paper transporting path, and is transferred in the sub-scanning direction by the recording medium transporting unit 4, and thereby ink jet recording is performed by the recording head 36.

The structure of the printer 1 has been described above in brief. Now, the lower paper guide 50 and elements disposed in the vicinity thereof will be described in detail.

Referring to FIGS. 3 and 4, the lower paper guide 50 includes the platen 56 disposed on the downstream side of the transport driving roller 30 and a rear paper guide 57 disposed on the upstream side of the transport driving roller 30 in an integrated manner. In addition, the lower paper guide 50 is formed of resin in an integrated manner so as to be able to support the transport driving roller 30 and the rotation axis 40 of the discharge driving roller 41.

The platen 56 is disposed so as to face the recording head 36, and supports the paper P from the bottom side. Thus, the platen 56 defines the distance, that is, the PG, between the paper P and the recording head 36, and guides the paper P toward the downstream side. The rear paper guide 57 guides the paper P which is fed from the feeding unit 2 toward the transport driving roller 30.

A portion where the platen 56 faces the recording head 36 is disposed in the main-scanning direction with a plurality of ribs that extend in the sub-scanning direction, which are spaced apart from one another. The ribs are composed of four types of rib, that is, the first rib 51, the second rib 52, the third rib 53, and a fourth rib 58, when viewed from the upstream side in the sub-scanning direction. That is, the first rib 51 that extends in the sub-scanning direction is disposed near the downstream side of the transport driving roller 30. Further, the second rib 52 that extends in the sub-scanning direction is disposed on the downstream side of the first rib 51, while being interposed between the first rib 51 and a groove 54. Furthermore, the third rib 53 that extends in the sub-scanning direction is disposed on the downstream side of the second rib 52, while being interposed between the second rib 52 and the groove 55.

As shown in FIG. 3, pluralities-of the first rib 51, the second rib 52, and the third rib 53 are disposed, being spaced apart from one another by a suitable distance, and support the paper P from the bottom side so as to define the PG. In addition, a fourth rib 58 is disposed near either side of the discharge driving roller 41, and guides the paper P between the discharge driving roller 41 and the discharge driven roller 42.

A reference S in the recording head 36 indicates the range of an ink ejecting nozzle (not shown) in the sub-scanning direction. As shown in the drawing, the second rib 52 is positioned within the range of the ink ejecting nozzle, whereas the first rib 51 and the third rib 53 are positioned outside the range of the ink ejecting nozzle.

As described above, the groove 54 that extends in the main-scanning direction is formed between the first rib 51 and the second rib 52. Likewise, the groove 55 that extends in the main-scanning direction is formed between the second rib 52 and the third rib 53. The groove 54 and the groove 55 are provided to dump ink that is ejected onto a portion outside the upper or lower edges of the paper P. That is, ink droplets are ejected onto the portion outside the upper or the lower edge of the,paper P in a state that the upper edge of the paper P is disposed at the upper portion of the groove 55. Accordingly, recording can be performed such that the upper edge of the paper P has no blank space. In addition, ink droplets ejected outside the upper edge of the paper P can be dumped into the groove 55. Further, the ink droplets are ejected onto the upper edge of the paper P or the portion outside the upper edge of the paper P in a state that the lower edge of the paper P is disposed at the upper portion of the groove 54. Accordingly, recording can be performed such that the lower edge of the paper P has no blank space. In addition, the ink droplets ejected outside the lower edge of the paper P can be dumped into the groove 54.

Referring now to FIG. 5, the relationship between the first rib 51, the second rib 52, and the third rib 53 will be described in terms of height. For clear understanding of the upper and lower positional relationships shown in FIG. 4, the upper and lower positional relationships among the first rib 51, the second rib 52, the third rib 53, the recording medium transporting unit 4, the recording head 36, the auxiliary roller 43, and the recording medium discharging unit 5 are exaggerated.

Referring to FIG. 5, a reference Lr denotes a straight line (a common tangential line of the two rollers) that connects a contact point of the paper P with respect to the transport driving roller 30 and a contact point of the paper P with respect to the discharge driven roller 42. A reference A denotes the distance between the top of the second rib 52 and the straight line Lr. A reference B denotes a gap between the top of the second rib 52 and the top of the third rib 53. A reference C denotes a gap between the top of the third rib 53 and a contact point of the paper P with respect to the auxiliary roller 43. Further, a reference a denotes the distance of the paper transporting path ranging from a downstream end portion of the top of the second rib 52 to the auxiliary roller 43, and a reference b denotes the distance of the paper transporting path ranging from the auxiliary roller 43 to the recording medium discharging unit 5. In addition, a reference α denotes the angle between a straight line that connects an axis center of the transport driving roller 30 and an axis center of the transport driven roller 31 and a line perpendicular to the straight line Lr. Further, a reference β denotes the angle between a straight line that connects an axis center of the discharge driving roller 41 and an axis center of the discharge driven roller 42 and a line perpendicular to the straight line Lr.

In FIG. 5, the axis center of the transport driven roller 31 is located on the downstream side (the left side in FIG. 5) of the paper transporting path with respect to the axis center of the transport driving roller 30, and thus a straight line that passes through the axis centers of the two rollers 30 and 31 has a tilt angle α as shown in the drawing. Likewise, the axis center of the discharge driven roller 42 is located on the upstream side (the right side in FIG. 5) of the paper transporting path with respect to the axis center of the discharge driving roller 41, and thus a straight line that passes through the axis centers of the two rollers 41 and 42 has a tilt angle β as shown in the drawing. Accordingly, the paper P is convexly curved downwards between the recording medium transporting unit 4 and the recording medium discharging unit 5, and is pressed down toward each rib of the platen 56. As a result, the paper P is prevented from lifting from the platen 56.

In this case, the paper P is strongly pressed in a pinch manner by the transport driving roller 30 and the transport driven roller 31. In addition, the recording head 36 is positioned toward the recording medium transporting unit 4 between the recording medium transporting unit 4 and the recording medium discharging unit 5. Therefore, even before the upper edge of the paper P reaches the recording medium discharging unit 5, the upper edge of the paper P is relatively strongly pressed toward the platen 56, and thus is prevented from lifting from the platen 56 at a position facing the recording head 36.

On the other hand, as for the lower edge of the paper P, the paper P cannot be sufficiently pressed toward the platen 56 by the recording medium discharging unit 5 alone if the paper P cannot be set to be strongly pressed, in a pinch manner by means of the discharge driving roller 41 and the discharge driven roller 42 (since a roller mark is formed by the teeth located on the outer circumferential surface of the discharge driven roller 42), and if the recording medium discharging unit 5 and the recording medium transporting unit 4 are significantly spaced apart from each other. Accordingly, even after the lower edge of the paper P exits the recording medium transporting unit 4 when the paper P is pushed down toward the platen 56 by means of the auxiliary roller 43, the lower edge of the paper P can be prevented from lifting from the platen 56.

For example, however, if the paper P is specialized paper having a coating layer on its recording surface, the paper P is prone to having a curved portion (curl) due to a difference in expansion rate between the coating layer of the front surface and the base layer of the rear surface. In particular, the paper P is easily deformed to be convexly curved upwards due to expansion of the coating layer. Therefore, when the lower edge of the paper P is deviated from the recording medium transporting unit 4, that is, when the paper P is released from a strong restraint force of the recording medium transporting unit 4, the paper P is curved, and recording quality may deteriorate due to head friction or variation in the PG.

In order to solve the above problems, the paper P has to be pressed with certainty toward the platen 56 between the recording medium discharging unit 5 and the auxiliary roller 43. Further, the recording medium discharging unit 5 may be shifted upwards as shown in FIG. 5. In this case, the straight line Lr is tilted against the head surface of the recording head 36, and recording quality may deteriorate when recording is performed on an extremely rigid medium that is hardly curved, such as an optical disk or a paperboard.

For this reason, in the present embodiment, the protrusion height of the third rib 53 toward the recording head 36 is lower than those of the first rib 51 and the second rib 52, each of which has the same protrusion height.

Specifically, in the present embodiment, the top of the first rib 51 and the top of the second rib 52 are located to be almost at the same level. On the other hand, the top of the third rib 53 is located lower than the top of the first rib 51 and the top of the second rib 52 by a gap B. That is, the protrusion height of the third rib 53 toward the recording head 36 is lower than those of the first rib 51 and the second rib 52, each of which has the same protrusion height. That is, a space is formed so as to press with certainty the lower edge of the paper P toward the platen 56.

As a result, it is possible to dispose the contact point of the paper P with respect to the auxiliary roller 43 in such a direction that the contact point is more separated from the recording head 36 than the top of the first rib 51 and the top of the second rib 52 (gap C<gap B).

Accordingly, since the paper P can be strongly pressed toward the platen 56 by the recording medium discharging unit 5 and the auxiliary roller 43, the paper P can be further prevented with certainty from lifting from the platen 56. In particular, the paper P can be prevented from being deformed when the lower edge of the paper P is released from being strongly pinched between the transport driving roller 30 and the transport driven roller 31, or the degree of deformation may decrease.

Since the contact point of the paper P with respect to the auxiliary roller 43 is located below the top of the second rib 52, the leading edge of the paper P easily abuts (collide) against the auxiliary roller 43 when the leading edge of the paper P reaches from the second rib 52 to the auxiliary roller 43. Thus, it is preferable that the distance a of the drawing is determined to be as large as possible. In addition, since the gap between a nip point of the discharge driving roller 41 with respect to the discharge driven roller 42 and a contact point of the paper P with respect to the auxiliary roller 43 has widened, it is preferable that the top of the fourth rib 58 located within the distance b of the drawing has a tilted surface as shown in the drawing, so that the leading edge of the paper P that has passed the auxiliary roller 43 can be smoothly nipped between the discharge driving roller 41 and the discharge driven roller 42. Therefore, in the present embodiment, the distance a is defined as 19 to 21 mm. In addition, the distance b is defined as 20 to 22 mm. In addition, the gap B is defined as approximately 0.5 mm, and the gap C is defined as approximately 0.35 mm.

Although the paper P is pressed toward the platen 56 by the recording medium discharging unit 5 and the recording medium transporting unit 4 in the present embodiment, the auxiliary roller 43 becomes unnecessary if the paper P can be sufficiently pressed by using only the recording medium discharging unit 5. That is, even with a structure not having the auxiliary roller 43, it is possible to achieve the same effect as in the case of the structure in which the protrusion height of the third rib 53 toward the recording head 36 is lower than those of the first rib 51 and the second rib 52, each of which has the same protrusion height.

Meanwhile, in the present embodiment, although the first rib 51 and the second rib 52 are constructed to have substantially the same height to the top thereof, manufacturing errors are controlled so that the second rib 52 does not protrude from the first rib 51 toward the recording head 36. That is, if the second rib 52 protrudes from the first rib 51 toward the recording head 36, when the upper edge of the paper P reaches the second rib 52, the feeding direction of the upper edge of the paper P faces upwards. As a result, the upper edge of the paper P may be abraded due to the recording head 36. Therefore, the second rib 52 has to be formed so as not to protrude toward the recording head 36 with respect to the first rib 51.

A positional relationship among the transport driven roller 31, the first rib 51, the second rib 52, the third rib 53, the recording medium transporting unit 4, and the auxiliary roller 43 in the main-scanning direction will now be described with reference to FIGS. 6 and 7. For simplicity, only the aforementioned elements are shown in FIGS. 6 and 7, and the rest of elements are omitted. Hereinafter, three ribs (the first rib 51, the second rib 52, and the third rib, 53) of which main-scanning directions coincide with one another will be simply referred to as a rib R.

If the paper P expands and elongates by absorbing ink, the distance between the recording surface of the paper P and the recording head 36 is likely to be uneven. Therefore, the ink jet printer is constructed such that the distance between the recording surface and the recording head 36 remains constant as much as possible even if the paper P elongates, by compulsively forming a waveform state (a cockling shape state) in which the elongated portion is located between two ribs R, that is a position of a rib R forms a convex portion, and a position between the two ribs R forms a concave portion.

In the present embodiment, in order for the cockling shape state to be ensured without causing complexity of the apparatus, each of the elements is disposed as follows.

That is, a reference F in FIG. 6(A) (or FIG. 7(A)) indicates a position where the one end 25a (see FIG. 3) of the coil spring 25 presses the upper paper guide 24 against the transport driving roller 30. As shown in the drawing, the coil spring 25 applies force to a center portion between the two transport driven rollers 31 in the upper paper guide 24.

In other words, the reference F indicates a position where a load is concentrated when the paper P is pressed in a pinch manner by the transport driving roller 30 and the transport driven roller 31. This position is prone to be the concave portion when the cockling is formed in the paper P. Therefore, by utilizing this property, the position F is determined as the concave portion when the cockling is formed in the paper P, and is disposed between the two ribs R located in the main-scanning direction, while being spaced apart from each other by a specific gap.

Accordingly, as shown mimetically in FIG. 6(B), the cockling is formed in the paper P such that the position of the rib R forms the convex portion, and the position F where the load is concentrated forms the concave portion. As a result, it becomes possible that the cockling is surely formed in the paper P without causing a complex structure and a cost increase. In addition, recording quality can be avoided against deterioration.

In particular, the upper edge of the paper P is not influenced by a restriction force of the recording medium discharging unit 5 until the upper edge of the paper P reaches the recording medium discharging unit 5. For this reason, the cockling shape is not easily formed in general. However, since the position F, at which the load is concentrated when the paper P is pressed in a sandwich manner by the transport driving roller 30 and the transport driven roller 31, is disposed between the two ribs R, the cockling is formed even in the upper edge of the paper P by the ribs R together with the transport driving roller 30 and the transport driven roller 31. Further, even before the upper edge of the paper P reaches to the recording medium discharging unit 5, the cockling shape can be formed in the paper P. That is, it becomes possible to avoid recording quality against deterioration caused by the head friction in the upper edge of the paper P or variation in the PG.

In the state that the cockling shape is formed in the paper P, the more convex portions and concave portions, that is, the shorter a cockling period, the more possible the variation of the PG can be restricted. Hence, as shown in FIGS. 7(A) and 7(B), deterioration in recording quality can be further prevented by installing more ribs R at the position F where the load is concentrated when the paper P is pressed by the transport driving roller 30 and the transport driven roller 31 and by shortening the cockling period.

In the embodiment of FIG. 7, the position F, at which the load is concentrated, and the ribs R are alternated, and thereby the convex portions and the concave portions are alternately formed in a regular manner, which leads to further prevention of deterioration in printing quality.

In the case of a specialized paper of A4 size having a coating layer in the range of 0.2 to 0.3 mm in thickness, it has been known that the most desirable recording quality can be obtained when six concave portions are formed as shown in FIG. 7.

The amount of elongation that occurs when the paper P absorbs ink and thus expands is likely to be larger in a center portion of the paper P than a side edge portion of the paper P. By taking this property into account, therefore, it may be effective to shorten the cockling period (a gap between two ribs R) at the center portion of the paper P than the cockling period at the side edge portion of the paper P.

When the paper P is deformed such that the center portion is convexly curved toward the recording head 36 (for example, similar to the case of paper in which its coating layer absorbs ink and thus expands and of which the recording surface is formed with the coating layer), the center portion of the paper P easily causes deterioration in recording quality due to the head friction or the PG variation. Hence, in the present embodiment, the ribs R supporting the both edge portions of the paper P having a specialized size are formed such that the protrusion heights thereof toward the recording head 36 are lower than those of other ribs R, each of which has the same protrusion height and supports the paper P from the bottom side between the both edge portions.

Specifically, referring to. FIG. 6, references L₁, and L₈₀ respectively indicate positions at which both side edges of paper of A4 size (210 mm in width) pass, and the rib R (the rib R formed in the range indicated by a reference A₁ and a reference A₃) located at a position supporting the both side edges of the paper of A4 size is formed such that its protrusion height toward the recording head 36 is lower than those of other ribs R, each of which has the same protrusion height. Likewise, in the present embodiment, the rib R (formed in the range indicated by a reference A₂) located at a position, at which one side edge of paper of an L board size (89 mm in width) and paper of a 4×6 size (101.6 mm in width) passes, is also formed such that its protrusion height toward the recording head 36 is lower than those of other ribs R, each of which has the same protrusion height. In addition, the reference L₁ denotes a position at which one side edge of paper of all sizes passes.

Accordingly, even if the center portion of the paper P is deformed (curled) to be convexly curved toward the recording head 36, the distance between the recording surface and the recording head 36 can be secured. Further, deterioration in recording quality caused by the head friction or the PG variation can be prevented.

Although the invention has been described with reference to exemplary embodiments, it is possible to adjust the disposition of the rib R in the main-scanning direction or a height relationship of each of the ribs (the first rib 51, the second rib 52, and the third rib 53) with respect to the recording head 36 according to various conditions such as a paper type in use, an ink property, or the like, without departing from the spirit and scope of the invention.

What is claimed is:

1. A recording apparatus comprising:
a recording head that performs recording on a recording medium;
a recording medium transporting unit that is disposed on the upstream side of the recording head, and transports the recording medium toward the recording head;
a recording medium discharging unit that is disposed on the downstream side of the recording head, and discharges the recording medium on which recording has been performed; and
a platen that is disposed so as to face the recording head, and defines a gap between the recording medium and the recording head by supporting the recording medium,
wherein:
the recording medium transporting unit includes a transport driving roller that rotates, and a plurality of transport driven rollers that are spaced apart from one another in a main-scanning direction by a suitable distance and come in pressure contact with the transport driving roller to be driven to rotate;
the recording medium discharging unit includes a plurality of discharge driving rollers that are spaced apart from one another in the main-scanning direction by a suitable distance, and a plurality of discharge driven rollers that are driven to rotate while being in contact with the discharge driving rollers;
in the platen, a plurality of ribs that extend in a sub-scanning direction are disposed in a portion facing the recording head in the main-scanning direction while being spaced apart from one another by a suitable distance; and
the positions of the ribs in the main-scanning direction coincide with the positions of the discharge driving roller and the discharge driven roller, and a load is concentrated at a position between each adjacent pair of ribs when the recording medium is pressed in a pinch manner by the transport driving roller and the transport driven roller.

2. The recording apparatus according to claim 1, wherein the ribs and the positions at which the load is concentrated are alternated.

3. The recording apparatus according to claim 1, wherein the ribs are arranged so as to support underneath both side edges of the recording medium in the main scanning direction, and the ribs supporting both side edges of the recoded medium are formed such that protrusion heights thereof toward the recording head are lower than those of other ribs having the same protrusion height and supporting underneath the recording medium.

4. The recording apparatus according to claim 1, comprising an auxiliary roller that is located between the recording head and the recording medium discharge unit, and is driven to rotate while being in contact with the recording surface of the recoded medium, wherein two auxiliary rollers are disposed between the ribs.

5. A liquid ejecting apparatus comprising:
a liquid eject head that ejects liquid onto an target medium;
an target medium transporting unit that is disposed on the upstream side of the liquid ejecting head, and transports the target medium toward the liquid ejecting head;
an target medium discharging unit that is disposed on the downstream side of the liquid ejecting head, and discharges the target medium on which liquid has been ejected; and
a platen that is disposed so as to face the liquid ejecting head, and defines a gap between the target medium and the liquid ejecting head by supporting the target medium,
wherein:
the target medium transporting unit includes a transport driving roller that rotates, and a plurality of transport driven rollers that are spaced apart from one another in the widthwise direction of the target medium by a suitable distance and come in pressure contact with the transport driving roller to be driven to rotate;
the target medium discharging unit includes a plurality of discharge driving rollers that are spaced apart from one another in the widthwise direction of the target medium by a suitable distance, and a plurality of discharge driven rollers that are driven to rotate while being in contact with the discharge driving rollers;
in the platen, a plurality of ribs that extend in a sub-scanning direction are disposed in a portion facing the liquid ejecting head in the main-scanning direction of the injected medium while being spaced apart from one another by a suitable distance; and
the positions of the ribs in the widthwise direction Of the target medium coincide with the positions of the discharge driving roller and the discharge driven roller, and a load is concentrated at a position between each adjacent pair of ribs when the target medium is pressed in a pinch manner by the transport driving roller and the transport driven roller.
